(19) United States
(12) Patent Application Publication
(10) Pub. No.: US 2026/0208767 A1
(43) Pub. Date: Jul. 23, 2026

(54) AUTONOMOUS CONTROL OF A DEVICE

(71) Applicant: Carl Albert Schreiber, VIENNA (AT)

(72) Inventor: Carl Albert Schreiber, VIENNA (AT)

(21) Appl. No.: 19/139,362

(22) PCT Filed: Jun. 19, 2023
(86) PCT No.: PCT/EP2023/066414

§ 371 Date: Jun. 15, 2025

(30) Foreign Application Priority Data
Dec. 15, 2022 (EP) 22214016.2

(51) Int. Cl. B60W 60/00; B60W 50/00

(52) U.S. Cl. CPC B60W 60/00274; B60W 50/0097; B60W 2420/403; B60W 2420/408; B60W 2420/54; B60W 2554/4045; B60W 2554/4046; B60W 2554/80

(57) ABSTRACT

The present invention is directed to a method for autonomously controlling a device, whereby the device generally moves in a physical real world and no longer needs to be restricted in terms of its physical configuration. The method creates the advantage that the device performs autonomous learning and continuously improves the learned knowledge or behaviour. In general, it overcomes the disadvantage in the prior art that training data must first be created and provided, as is the case with conventional artificial intelligence methods. In general, the method can be used universally and the device learns automatically and always corrects its own knowledge base. In addition, a device is proposed which is set up to carry out the method, as well as a system arrangement comprising several of the proposed devices. In addition, a computer program product and a computer-readable storage medium are proposed, which execute the method steps or cause a computer to execute the method.

The present invention is directed to a method for autonomously controlling a device, whereby the device generally moves in a physical real world and does not need to be further specified with regard to its physical configuration. The method creates the advantage that the device performs autonomous learning and continuously improves the learned knowledge or behaviour. In general, it overcomes the disadvantage in the prior art that training data must first be created, as is the case with conventional artificial intelligence methods. In general, the method can be used universally and the device learns automatically and constantly corrects its own knowledge base. In addition, a device is proposed which is set up to carry out the method, as well as a system arrangement comprising several of the proposed devices. In addition, a computer program product and a computer-readable storage medium are proposed, which execute the method steps or cause a computer to execute the method.

TAKAHASHI KUNIYUKI ET AL: “Dynamic motion learning for multi-DOF flexible-joint robots using active-passive motor babbling through deep learning”, ADVANCED ROBOTICS, vol. 31, no. 18 17 Sep. 2017, pages 1002-1015, XP055840673 shows a learning strategy for multi-degree-of-freedom flexible-joint robots to perform dynamic motion tasks. Although robots with flexible joints offer several potential advantages, such as exploiting intrinsic dynamics and passively adapting to environmental changes with mechanical compliance, controlling such robots is challenging due to the increasing complexity of their dynamics.

Various methods from artificial intelligence AI are known from the state of the art, which envisage training data to be selected and provided and algorithms to recognise regularities in a training phase. Here it is possible that special algorithms recognise regularities through the specifications of initial data and target values and through and these are then used. This means that implicit knowledge can be utilised within large amounts of data. Once the training phase is complete, the appropriately trained algorithms are applied to actual data and in turn generate implicit dependencies to solve real-world problems. One disadvantage here is that the training data must first be selected and specified, which limits the resulting artificial intelligence to the training data, and undesirable influence on the learning phase can already be exerted here, which is not only error-prone but also costly.

Swarm intelligence is also known from the state of the art, whereby several devices are provided and these then collaboratively solve a problem in a distributed manner. Here too, the control and coordination of the individual participants is complex and sometimes error-prone. This is particularly true if distributed learning is to take place, which in turn has to be coordinated.

Artificial neural networks, which provide neurons and connections, i.e. nodes and edges, based on graph theory, are also known from the state of the art. It is known that these networks mimic the functions of the human brain and can also learn. Edge weights can be varied, new edges can be added or old ones deleted and existing nodes can be deactivated or new nodes can be added. This results in a dynamically learning overall system.

However, the use of an ANN in the manner presented above has at least four problems:
1. For objects on which the ANN has not been trained, the ANN does not provide any information to call up the routines assigned to the object.
2. The programmed properties or behaviours of the detected and identified objects can either be incorrect, have changed in the meantime or are still unknown.
3. One or more scientists, experts, etc. select the training data and specify the results to be achieved. Even with unsupervised learning, the training data and hyperparameters are still specified by humans and this cannot rule out errors.
4. An ANN cannot correct errors. Each individual piece of information is distributed across all the parameters of the ANN, similar to a hologram in which each data point contains information about the entire image. An ANN must therefore always be completely deleted and completely retrained.

This means that there is no failure of recognition (unlike with ANNs) when the Ego encounters a previously unknown object, such as in the video when the self-driving car suddenly sees two boxes on the carriageway. ANN generally stands for an artificial neural network.

In the state of the art, there is a need to create an autonomous control of devices in such a way that time-consuming preparatory work such as the provision of training data and teaching can be prevented or minimised. There is therefore a need for a self-learning system that is also able to learn collectively or estimate what other participants are likely to do or can do at all. There is therefore a need for a system that comprises several participants, whereby each participant actually also has knowledge about the other participants and develops this further, which is referred to here as empathy.

Accordingly, it is a task of the present invention to propose a method for the autonomous control of a device, which acts independently solely on the basis of target information provided and builds up action knowledge in the process. The proposed method should be able to recognise the scope of action of effectors of any device and create an improved method or at least an alternative method for autonomously controlling the device or devices. Furthermore, it is a task of the present invention to propose a device for carrying out the method as well as a system arrangement comprising several of the proposed devices. Furthermore, it is a task to propose a computer program product and a computer-readable storage medium which contain instructions which execute the method.

The problem is solved with the features of claim 1. Further advantageous embodiments are given in the subclaims.

Accordingly, a method for autonomously controlling a device is proposed, comprising initialising by means of randomised actuation of effectors and reading out a plurality of internal sensor units set up to measure internal device properties and reading out a plurality of external sensor units set up to measure external environmental properties; storing correlations which exist between the actuation of the effectors and the readout device properties and environmental properties as action instructions, such that an action instruction converts an initial triplet of actuation, device properties and environmental properties into a target triplet; and actuating the device according to at least one predefined target device property and/or at least one predefined target environment property using at least one stored action instruction indicating how to set the at least one predefined target device property and/or the at least one predefined target environment property based on the initial triplet and the target triplet, wherein the method is iterated in a learning manner, in which new action instructions are constantly recognised, each of which converts an initial triplet into a target triplet and these action instructions are stored for controlling the device.

The proposed method is used to autonomously control, i.e. create instructions for action, a device that is generally physical. This may be an automobile, a robot or a production plant. In terms of mobility, no restrictions are envisaged here, meaning that the device can move on land, in the air, on water or even under water. Autonomous in this context means that the method ensures that the device learns automatically and also recognises automatically which possible actions are available. These can be learnt and the sensors are used to learn which action leads from which starting point to which result. In general, it is possible for the device to provide its own targets or for the targets to be transmitted externally. The device's own targets may, for example, be to maintain operational capability. An internal objective can be, for example, to visit a charging station when the battery level is low. An external objective can be transmitted by specifying which task or activity the device should perform.

In a preparatory process step, initialisation takes place by means of randomised actuation of effectors. An effector is generally a physical unit that has an influence on the real world. This can, for example, affect the device itself, such as steering, accelerating, braking, etc., and/or the targeted manipulation of objects by, for example, robot arms, directly or with tools, or by instruments with a remote effect, be they projectiles or jets or, for example, fire-fighting agents such as water or extinguishing foams. In the example of the car, this can be the brake, accelerator pedal, etc., but also headlights, indicators, etc. The effectors are actuated and then the effects of these actions are measured using the internal and external sensors. This is recorded and can then be used in the further course of the process. In this way, actions are learnt and used in a targeted manner in later process steps.

Since the proposed device or the proposed method can be carried out or controlled entirely without initial knowledge, the preparatory step is a randomised actuation, i.e. an arbitrary actuation, since it must first be learned which action leads to which result. In further iterations of the process, the learnt actions are then actuated in a targeted manner. During randomised actuation, the system parameters of the effectors are checked and, for example, a robot arm is moved to all possible positions. This is logged in each case and it is recognised which action of the effector has what effect on the real world. In the example of a spotlight, it is possible that it only provides the parameters on and off. It is then switched on and off and the external sensor system is used to measure the influence of the headlamp on the environment and the internal sensor system is used to measure the operating parameters of the headlamp, such as temperature development. With advanced LED headlights, it is also possible to adjust both the colour and the intensity. This is tested by means of randomised actuation and internal and external results are then logged.

According to the invention, internal sensor units and external sensor units are proposed. Internal and external do not refer to the arrangement of the sensor units, but rather, according to the present invention, to the fact that the sensor units measure external conditions with respect to the device or, analogously, internal conditions. Internal conditions are all system parameters of the device itself. External conditions are environmental variables, i.e. of objects surrounding the device. This means that the internal sensor units are used to measure device properties and the external sensor units are used to measure environmental properties. For example, if the device has a certain battery status, this is an internal parameter. If an object is transferred from A to B by means of a robot arm, this is an external state, whereby the state of the robot arm is in turn an internal state. Typically, therefore, internal and external parameters interact and actions always result in a reduced battery state, for example, while these actions in turn affect external properties. In another direction, it is an interaction that the device can be brought to a charging station by means of effectors and then a charging process is initiated, which in turn influences the internal battery status.

The recorded interactions are then saved and a record is made of how the actuation of the effectors influences the internal and external parameters. The device properties are therefore stored together with the environmental properties and instructions for action are defined. Actuating the effectors is therefore an action that influences both the device itself and the environment. For example, if the device moves from a first geographical point to a second geographical point, this changes the environment of the device, which is an external parameter, and this also changes the internal state of the device, for example through a change in temperature or a change in the battery state. A triple can therefore be stored, which indicates what the internal state was, what the external state was and what action is then executed. This is converted into a new internal state and a new external state. This means that there is an initial triplet from the actuation of the effectors, device properties and environmental properties and this is transferred to a target triplet. The new internal state, the new external state and possible actions can be specified in the target triplet.

The concept of triples is merely intended to illustrate the general transition of system states. In general, it is also possible for internal states and external states to be transformed into a new internal state and a new external state by means of a function. The action therefore consists of a mapping function from a first tuple to a second tuple. The skilled person will recognise that the power of both descriptions is equivalent. Either an initial tuple is converted into a target tuple by means of a function or an input triple is formed, which specifies internal states, external states and an action, whereby this action then leads to a target triple, which has a new internal state, a new external state and a further field. The further field can either remain empty, although it is preferable that at least one action is executed here that is now possible in this state. The last field can also be filled in such a way that, for example, a vector is introduced here that contains the identifiers of further actions.

To illustrate this with an example, the device can actuate the effector called motor drive and drive forwards. What is now logged is an initial triplet of an internal state, namely a battery charge level, an external state, namely an image signal of a physical environment and an action instruction, namely “drive”. This initial vector or initial triplet is now converted into a target triplet, which has a new battery charge level, a new image signal from the environment and actions that would now be possible, such as driving forwards or reversing. During the forward movement action, it is also possible to specify that braking or activating the headlights would be possible, for example.

In an alternative example, the initial tuple of the battery status and the image signal of the environment is converted into a target tuple using the “Move” function, which describes the new battery status and a new image signal of the environment. This logs what happens internally and externally during a particular action. This knowledge can be reused in further action steps towards a predefined target.

In further process steps, target device properties or predefined target environment properties can be provided. Thus, the device can be controlled in such a way that the at least one predefined target device property and/or the at least one predefined target environment property is set. The instructions for action are known from the previous method steps, and it is therefore known how an internal state and an external state can be converted into a further internal state and a further external state. The target specifications, i.e. the target device property and/or the target environment property, are used for this purpose. These target properties therefore determine what is to be achieved and this is done by executing the action instructions. The state of the device is therefore read out and stored actions are then selected which, based on the actual state, achieve the target state. In a preferred case, it is sufficient to execute an action instruction that immediately achieves the target specifications. In a typical case, however, it will be the case that the initial state is successively transferred to the target state by means of several action properties. In other words, several action instructions are linked in such a way that the targets are ultimately achieved.

To illustrate this in an example, the procedure can have identified that the device can move from A to B to C to D. This means that the instructions are stored that the car can travel from A to B, from B to C and from C to D. It is also implicitly memorised that the car can drive from A to C and from A to D. It is also stored that the car can drive from C to D. These options are now used and if there is a destination specification that says that the car should drive from A to C, the device has two options to choose from, namely to drive from A to B to C or to drive from A to C. In general, it would also be possible to drive from A to D and then from D to C. Which selection is made can also be defined in the destination specifications. For example, a maximum duration of the journey can be defined in terms of time. In addition, a maximum energy consumption can be defined. Actions are therefore randomised in preparatory process steps and these are then available at runtime. In general, the procedure can provide for randomised actuation of the effectors, but it can also add the reuse of previously learnt instructions. This means that a learning phase of randomised actuation can be carried out, as well as an execution phase that uses actions that have already been saved. This can also be alternated in any order. In addition, the stored action knowledge is also refined in the execution phase by means of the internal sensors and the external sensors and new action instructions are generated, which may be favoured with regard to a different target. In addition, the targets can also change during the execution of an action in such a way that, for example, a battery condition becomes critical and, in this respect, the target of the vehicle's own operability is increased in such a way that the process recognises that it is now necessary to drive to a charging station. This results, at least temporarily, in a superimposed target, namely to travel to a charging station, even if this does not achieve the goal of travelling to the original target coordinate. As soon as a certain charge level is reached, the target of the vehicle's own operability is downgraded again and the target of travelling to the destination is increased so that the journey is now continued.

According to one aspect of the present invention, the method is iterated in a learning manner such that new instructions for action are always recognised, which in each case convert an initial triplet into a target triplet and these instructions for action are stored for actuating the device. This has the advantage that the method is established in whole or at least partially in such a way that new situations are always recognised and instructions for action are created in such a way that effectors are actuated. The method can be varied in such a way that the actuation of the effectors is no longer randomised, but rather existing instructions for action can be combined or it is also possible that parts of existing instructions for action are randomised so that new possible instructions for action are created with regard to which it is also clear which interactions they trigger. In addition, the procedure can also be established in such a way that, starting from the storage of interactions, it is established up to the control of the device. This means that interactions are also saved when known instructions are executed and new parameters can be identified. For example, it can be recognised that different target parameters are created when the same action instruction is executed twice. This can be the case, for example, if a crosswind arises when driving a car. This is saved and the external sensor then recognises that a wind must have occurred here. This creates a new initial triple and the effectors can be used to randomly try out how to counter-steer in such a situation. This means that new interrelationships have been recognised and if such an initial triplet is identified again, it is now clear which action must be carried out in order to achieve the desired target triplet.

According to a further aspect of the present invention, internal and/or external effectors are read out in such a way that individual support values are stored and intermediate values are interpolated and/or extrapolated. This has the advantage that the support values can be selected according to their availability and that these can also be estimated in such a way that a measurement does not have to be available at every possible value. Instead, existing measurements can be used to estimate which values would result under normal circumstances. This means that further support values can be calculated mathematically.

According to a further aspect of the present invention, the target device property and/or the target environment property is at least temporarily influenced by a device property and/or an environment property. This has the advantage that the target specifications can also be changed or are subject to prioritisation. If, for example, a second geographical point is to be reached from a first geographical point at, the approach to a charging station can be prioritised in the meantime, as otherwise the final destination would not be reached. This therefore has the advantage that it is always guaranteed that the targets will be reached and a fail-safe procedure is created.

According to a further aspect of the present invention, several action instructions are combined to form a choreography which converts a initial triplet into a target triplet. This has the advantage that even complex, i.e. compound actions can be carried out and, as the method progresses or is established, new instructions for action are constantly created, which are combined to form increasingly efficient choreographies. The proposed procedure is therefore improved iteratively.

According to a further aspect of the present invention, an object is detected using external sensors and its detected parameters are compared with device properties and/or instructions for the devices. This has the advantage that the device can virtually clone itself or infer the properties of the object from its own properties. This can also be referred to as empathy. If, for example, the external sensors identify a device that has similar characteristics to the executing device, it is assumed that this newly recognised device has similar capabilities to the executing device. To illustrate this in an example, a vehicle that carries out the proposed invention is used. This first vehicle thus carries out the proposed method and recognises a further, i.e. second, device by means of an external sensor, in this case an imaging unit. The first device or the first vehicle has learnt that it can only brake to a limited extent at a certain speed and can only steer transversely to a limited extent. The first vehicle now recognises that the second vehicle has similar dimensions and is travelling at a similar speed to the first vehicle. The instructions are then conceptually projected into the second vehicle and the first vehicle recognises that the second vehicle can only brake to a limited extent and can only change direction to a very limited extent. If an overtaking manoeuvre is now initiated on a motorway, the first vehicle recognises that the second vehicle could brake or also change lanes. It is therefore concluded from its own behaviour or the possible initial triplet and the possible target triplet that this object has similar characteristics. In addition, the external sensors can be used to monitor the behaviour of the detected second vehicle and then update the vehicle's own data memory, which stores interactions. This means that initial triplets and target triplets can also be recognised and conclusions can be drawn from the second vehicle to the first vehicle.

According to a further aspect of the present invention, the detected parameters are used to predict the behaviour of the detected object. This has the advantage that it is recognised that the own device executes a certain action instruction in a certain situation, so that the other detected object would very probably also execute the same action in the same situation. The user's own actions or executed instructions are therefore logged and it is then assumed that the detected object could behave in the same or at least a similar way.

According to a further aspect of the present invention, interrelationships of the detected object between its parameters and its actions are used to create instructions for the device. This has the advantage that externally recognised correlations relating to the proposed device or the device which is controlled by the method can also be used. Thus, the device does not only create interrelationships that are evaluated, but rather the external world can also be observed and conclusions about the transfer of initial triples into target triples can then be recognised.

According to a further aspect of the present invention, an effector is present as a processor, a memory, a motor, a gripper arm, a locomotion unit, a drive, an extremity, a windscreen wiper, an indicator, a light, a steering and/or an executive unit. This has the advantage that all possible hardware units can be present using the proposed device or the device to be controlled according to the method. The design is only exemplary and not exhaustive, so that any physical unit can be controlled autonomously according to the proposed method.

According to a further aspect of the present invention, internal sensor units detect an effector state, an effector setting, an effector position, a size, a weight, a dimension, a speed, an acceleration, a deceleration, a battery level, a range, a position, a processor utilisation, a memory utilisation and/or a system parameter of the device. This has the advantage that the internal sensor units can measure all parameters and states of the device that the method executes or that is executed or controlled by the method.

According to a further aspect of the present invention, external sensor units detect a distance, an object, a lidar signal, an image signal, a position, a size, a dimension, an acoustic signal and/or an external parameter. This has the advantage that the complete environment of the device can be analysed and recorded. All possible sensors that recognise the environment in any way can be used individually or in combination.

The problem is also solved by a device set up for carrying out a method according to one of the preceding claims, comprising an initialisation unit set up for initialisation by means of randomised actuation of effectors and readout of a plurality of internal sensor units set up for measuring internal device properties and a readout of a plurality of external sensor units set up for measuring external environmental properties; a memory unit set up for storing interrelationships which exist between the actuation of the effectors and the readout device properties and environmental properties as action instructions, such that an action instruction converts an initial triplet of actuation, device properties and environmental properties into a target triplet; and a control unit arranged to control the device in accordance with at least one predefined target device property and/or at least one predefined target environment property using at least one stored action instruction which indicates how the at least one predefined target device property and/or the at least one predefined target environment property is set on the basis of the initial triplet and the target triplet, wherein the method to be executed by the device is iterated in a learning manner, in which new action instructions are constantly recognised, each of which converts an initial triplet into a target triplet and these action instructions are stored for controlling the device.

The problem is also solved by an arrangement comprising several devices which are coupled by communication technology and exchange instructions for action.

The task is also solved by a computer program product with control commands that implement the proposed method or operate the proposed device.

According to the invention, it is particularly advantageous that the method can be used to operate the proposed devices and units. Furthermore, the proposed devices and units are suitable for carrying out the method according to the invention. Thus, in each case the device implements structural features which are suitable for carrying out the corresponding method. However, the structural features can also be designed as process steps. The proposed method also provides steps for implementing the function of the structural features. In addition, physical components can also be provided virtually or virtualised.

Further advantages, features and details of the invention are apparent from the following description, in which aspects of the invention are described in detail with reference to the drawings. The features mentioned in the claims and in the description may each be essential to the invention individually or in any combination. Likewise, the above-mentioned features and the features further described herein may be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are of an exemplary nature to explain the invention. The detailed description serves to inform the skilled person, therefore known setups, structures, and methods are not shown or explained in detail in the description so as not to impede understanding of the present description. The figures show:

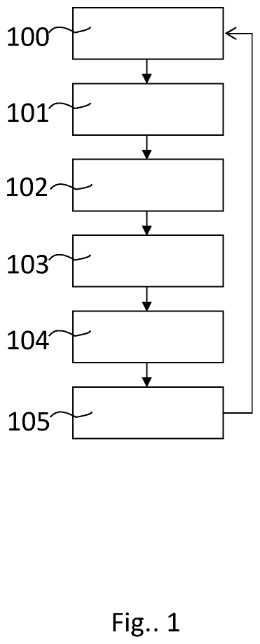

FIG. 1: a schematic flowchart of a method for autonomously controlling a device according to one aspect of the present invention;

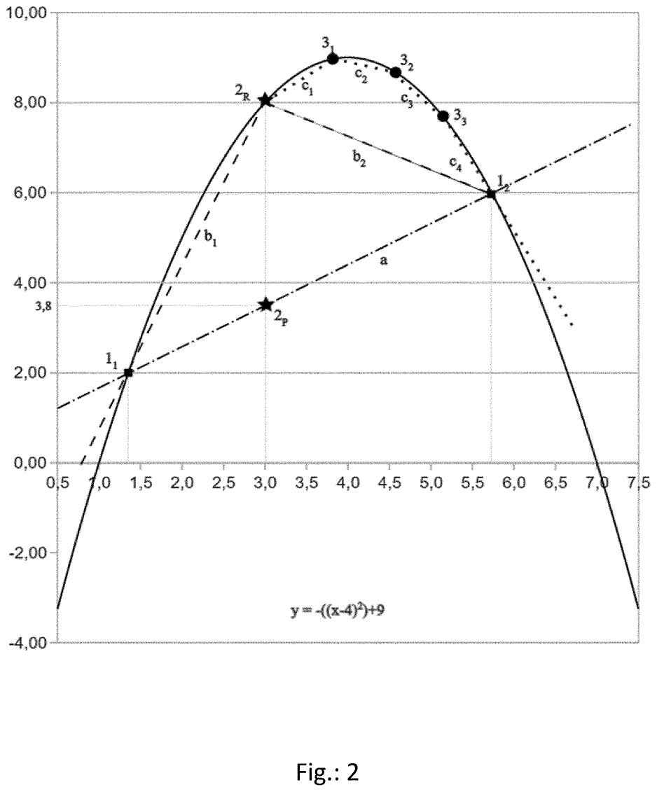

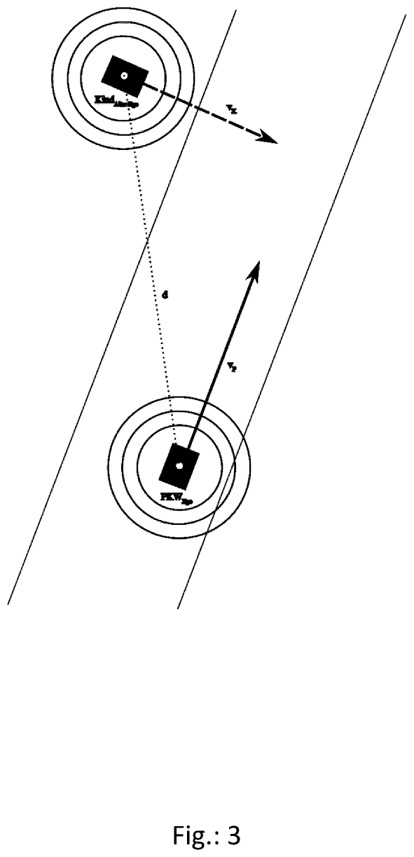

FIG. 2: a diagram that can be used to estimate internal and/or external properties. Internal and/or external parameters can be measured and interpolated between the supporting points or extrapolated from further supporting points;

FIG. 3: a representation of a real-world situation in which a child wants to cross a road and the proposed device recognises the situation and instructs from it;

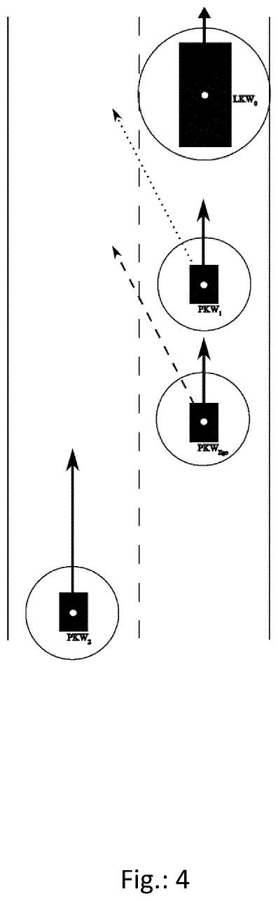

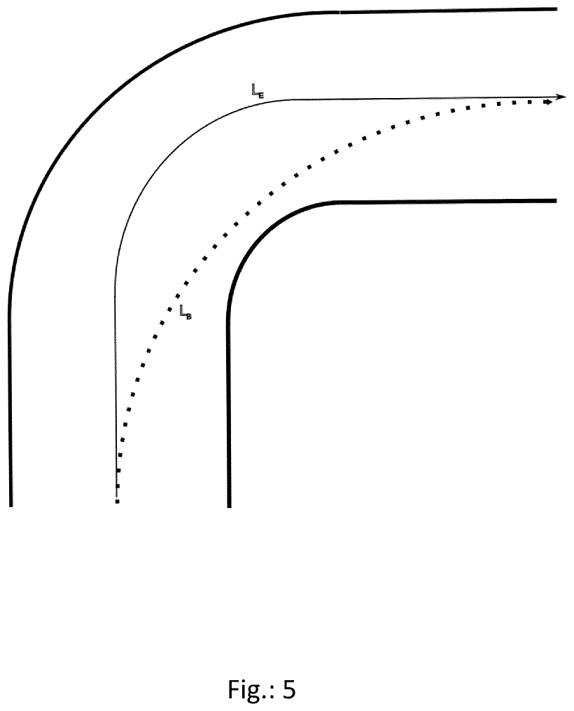

FIG. 4: a real-world situation in a road traffic situation in which the proposed device or method according to one aspect of the present invention is used; and

FIG. 5: a further real-world situation in a road traffic situation, wherein the device is practising cornering according to a further aspect of the present invention;

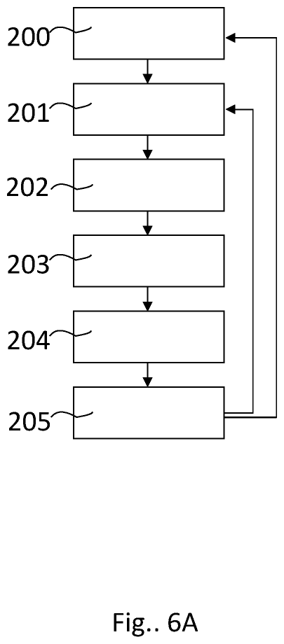

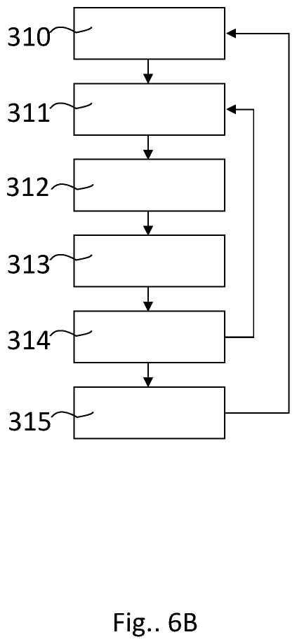

FIG. 6A: a schematic flowchart of a method for autonomously controlling a device according to one aspect of the present invention in the juvenile phase with the primary aim of making one's own actions more precise; and

FIG. 6B: a schematic flowchart of a method for autonomously controlling a device according to one aspect of the present invention in the adult, the application phase for achieving its own goals, taking into account and predicting the behaviour of the other objects relevant in a situation.

FIG. 1 shows in a schematic flow chart a method for autonomous control of a device, comprising initialisation 100 by means of randomised actuation 101 of effectors and readout 102 of a plurality of internal sensor units set up to measure internal device properties and a readout 103 of a plurality of external sensor units set up to measure external environmental properties; storing 104 correlations existing between the actuation 101 of the effectors and the readout device properties and environmental properties as action instructions, such that an action instruction converts an initial triplet of actuation 101, device properties and environmental properties into a target triplet; and actuating 105 the device according to at least one predefined target device property and/or at least one predefined target environment property using at least one stored 104 action instruction, which indicates how the at least one predefined target device property and/or the at least one predefined target environment property is set using the initial triple and the target triple, wherein the process is iterated in a learning manner, in which new action instructions are constantly recognised, which in each case convert an initial triple into a target triple and these action instructions are stored for controlling the device.

According to one aspect of the present invention, the model presented here uses a central template with which the AI finds its way in the unknown and constantly changing world. This approach makes it possible to create short-term behavioural predictions of the observed objects in order to estimate the development of situations and to take this into account when designing its own actions. It also enables learning from observation and empathy. Aspects of the invention are
Central template as the centre of the AI for recording all objects in a situation;
Data storage that enables laws to be recognised;
Behavioural predictions of all observed objects in a situation;
Empathy ability based on the central template;
Ability to learn from observation;
Recognising influencing factors that are not directly observable;
Recognising natural laws and causal dependencies;
Computerised form of theories that can be created, stored, reused and continuously improved; and/or
Self-assessment and the evaluation of self-generated theories as a basis for cognition, learning and the selection of the best theory for achieving one's own goals.

A car that behaves according to these ideas is described as an example. How does it judge a child or a box, how does it judge an overtaking manoeuvre on the motorway, or how does it recognise the law of gravity and crosswinds (as an example of the recognition of causalities and non-manifestable objects). It also describes how empathy can be used to learn from observation. All of this shows that the possibilities of this AI go beyond driving cars. However, the essential basis is a physically existing robot in a physically existing environment that observes other objects directly or indirectly.

In the following, some aspects of the present invention are proposed, which enable an exemplary implementation of the method or the device and/or the system arrangement. The following aspects are to be understood as merely exemplary and can be applied individually or in combination.

### Possible Hardware of the Robot or the Proposed Device:

The technical equipment that the robot or car may have according to one aspect of the present invention is described here.

### Effectors:

In simple cases such as a car, for example, the effectors would be, apart from windscreen wipers, indicators, lights, . . . . Braking, accelerating and steering, with which the robot influences its environment, even if it is only its own change of position, is also a change of situation.

### Internal Sensors:

The internal sensor system for measuring and providing feedback on the user's own characteristics such as height, weight, speed, acceleration etc. based on the actions of the effectors. They are necessary for the assessment of one's own actions and as a prerequisite for learning. This enables it to recognise its own actions, for example the strength of braking and the effect (the extent of negative acceleration), make connections and store them in memory in order to learn independently, i.e. to continuously improve its own actions.

As a physical entity in a physical environment, the robot is subject to the laws of physics. A measured acceleration, i.e. a change in speed, depends not only on the mass but also on how far the accelerator pedal is pressed or how hard the brake is applied. If these laws are not to be permanently programmed in, but the robot is to discover, store and use them itself, it needs internal sensors to learn and store the consequences of using the effectors. The internal sensors of a car, for example, therefore record data such as size, speed, acceleration, etc.

### External Sensors:

According to one aspect of the present invention, the external sensor system detects the environment (distances, objects, etc.), for example by means of lidar, image processing, etc. Of course, the robot must be provided with knowledge of the environment in a suitable manner. What exactly is required is described in more detail below. However, it should not be determined in advance which systems are best suited, as the information requirements are lower due to the use of the central template. Not everything that is theoretically available in terms of information needs to be recorded and processed.

### Possible Software of the Robot:

The parts by which the presented AI achieves its intelligence according to one aspect of the present invention are described herein.

### Data Storage:

The data storage is a highly available data memory for data tuples consisting of the data from the internal sensors, the effectors, the actions and their motivation values (see below). The memory appropriately combines actions performed and the associated actual, experienced and observed results. It therefore only stores internal data in tables and not, for example, pixels of one or more images. There is therefore only data whose internal meaning is known.

According to one aspect of the present invention, a further part of this module is the repeated checking of the internal consistency of the data. This means that they must not contain any contradictions, structures that lead to loops or circles, etc. The aim is that only one decision may ever result from the data. The routine that checks this should also remove stored redundant data, not only to keep the database as lean as possible, but also to prevent over-adaptation. What is considered redundant depends on the type of theory formation.

FIG. 2 shows the theory formation according to one aspect of the present invention:

Using the simple means described here, the central template can reproduce any functional correlation, save it and use it for the forecast.

Braking or acceleration depend functionally on the accelerated mass and the force applied. However, this function is initially unknown because the mathematical function of the change in speed dV depends on the preconditions Vn (current speed, weight, etc.) and the use of the effectors Em (force on the accelerator pedal, steering, etc.), i.e:

$$dV = f ( Vn , Em ) \qquad ( 1 )$$

This function should be self-learned and not programmed in, as this allows what has been learnt to be expanded, corrected and improved later in the same way. The effective acceleration during braking (or accelerating) is linked to the (mathematically) independent variable of the force F (how hard the pedal is pressed) and the mass m according to the law F=m*a via the internal sensor system of the measured acceleration a. The principle by which the robot itself finds this equation is simple. To illustrate this, let's take a (different, arbitrary) quadratic function y=−((x−4)²)+9, which is to be modelled.

Let it be that initially only the two measured values at points 11 and 12 exist. Now let it be that a prediction p is required at the point x=3 (point 2), which leads to a value of y=3.8 via the straight line a between 11 and 12. However, as the error to the ex post measured value y=8.0 is far too large, this point 2R at x=3.0 and y=8.0 is taken into memory. As a result, either the degrees b1 between [11,2R] or b2 between [2R, 12] would be used for a new forecast. Over time, many more points (31, 32, 33, . . . ) are created in the above example, via which the functional relationship of x and y can be modelled with any accuracy by the respective straight lines along the data tuples (c1, c2, c3, . . . ). The accuracy is only limited by experience not (yet) gained and the size of the memory. Of course, this can be extended to any number of variables, if the computing and memory capacities allow it; instead of straight lines, hyperplanes a1x1+ . . . +anxn=const are used for prediction by means of piecewise linear interpolation or extrapolation.

However, in order to minimise the number of corner or data tuples stored, these can also be removed again: If an ex post analysis reveals that a data tuple is so close or even on the straight line/hypereplane between the two neighbouring tuples, then this tuple can be deleted as redundant. This not only reduces the memory requirement, but also the computational effort and the behaviour adapts better and better over time to the actual, albeit still unknown, mathematical function, which then leads to increasingly efficient behaviour over time.

This procedure also prevents over-adaptation, which must be taken into account when selecting and scoping the training data for an ANN. Redundant experiences are thus not stored again and again, which would completely overshadow the rarely occurring events, the so-called ‘black swans’ with potentially severe consequences.

Storing functional correlations of variables has another advantage, as in this way every possible inverse function is also stored, as the stored data tuples do not distinguish which values were the ‘dependent’ and which were the ‘independent’ when they occurred. In the above function, x is the independent variable and the corresponding y-value can be determined using the function y=−((x−4)²)+9. The x-value would have to be searched for in the database and, if the x-value is not explicitly stored, the y-value can be determined approximately using the next two x-values. However, you can also simply search for the y-value in the memory and determine an x-value using piecewise linear interpolation or extrapolation—this is much easier than trying to determine the inverse function of the above equation, for example.

In this very simple way, any functional interrelation can be modelled with any degree of precision, provided that the education of the action is sufficient, as in a complex sport. Of course, the accepted error ε can also be changed and adapted over time, whether it needs to be reduced in order to increase the required precision, or whether it can be increased in order to reduce the memory and computing effort, as this again influences the number of stored supporting and data points, it is a continuous optimisation in the ongoing process.

According to one aspect of the present invention, a theory of the rules and laws of a current situation is therefore defined as a self-contained, consistent data set from which the predictions of this theory can be calculated by the robot by means of piecewise linear interpolation or extrapolation. The data set consists of its own measurement results and possibly also the parameters of created Alter Egos. In this way, the robot can determine, save, reuse and improve each of its theories itself. As part of the self-assessment (see below), it is also able to select and apply the best specific theory (data set) in a situation, the one with the highest competence (see below).

### Actions:

According to one aspect of the present invention, an action is an ordered sequence of effector operations to achieve a goal. With the aid of the functional relationships between effectors, the internal parameters and the known effects known to the robot, actions can be designed. Initially, in the juvenile learning phase (see below), simple actions are performed. The AI learns to accelerate and brake, then accelerate, wait and hit a barrier (externally braked with a ‘risk of injury’), accelerate, steer, brake and so on. These simple actions are then put together to form increasingly complex ‘choreographies’ and these are then further optimised, for example by making braking softer by reducing pedal pressure as speed decreases and, for example, by making cornering more fluid. The optimisation is achieved by a motivation value (see below), which represents a kind of internal evaluation of the action performed. Of the stored (partial) ‘choreographies’, the one with the highest motivation value is selected. In this way, the AI can continuously improve the use of its effectors. In addition, the reference to the current situation and the action experiences made can be used to predict the user's own situation at future points in time, which forms the basis for the user's own action planning.

### Motivation Values:

Motivation values reflect a kind of reward. On the one hand, they are determined internally after a self-imposed goal has been achieved (successful); on the other hand, a motivation value can also be transmitted externally (well done). If, for example, a route is travelled with strong steering movements, low speed and yet high lateral accelerations, this sequence of actions receives a lower motivation value than the result of the ‘education’, after which the same route is travelled faster and yet with lower lateral accelerations. Of course, this must also be memorised.

The motivation values therefore represent a form of unspecified, intrinsic goals. They can be linked to long-term goals such as the end point of a journey or short-term intermediate goals such as visiting a petrol station when the tank is empty: as the tank decreases, the motivation value for ‘refuelling’ slowly increases until it is greater than that of the long-term goal. The pursuit of the long-distance destination is interrupted in favour of refuelling and then resumed.

### Target System:

According to one aspect of the present invention, the robot is always ‘switched on’, although it may of course have an off switch. It therefore always performs an activity. However, this also includes doing nothing (recharging) or optimising its own long-term memory of action options (sleeping) in a resting state. The action chosen is always the one that currently has the highest motivation value. If an action that is not currently being carried out reaches a higher motivation value than the action currently being carried out, it is cancelled, terminated or interrupted so that the action with the highest motivation can be carried out. If the motivation of such a car on the way from Munich to Hamburg to refuel or recharge the batteries becomes greater than reaching Hamburg, it will interrupt the journey at the next opportunity and head for a petrol station.

In the juvenile phase (see below), i.e. in the learning phase, of such a robot or car, the motivations of driving, braking, accelerating and cornering over short distances are given high motivation values, simply because the internal long-term memory signals that it should learn or reduce the action error in order to make its own actions more precise. Later, in the adult phase (see below), when such behaviour causes no or only insignificant changes in the data memory, the error reduction approaches zero, such behaviour becomes ‘boring’, it only receives low motivation values and then, for example, energy saving is preferred.

Thus, according to one aspect of the present invention, this target system avoids a fixation on reality, which would mean an interpretation of the same that could possibly prove to be wrong in the future.

### The Central Template, the Ego:

The central template represents the core and basis of this AI according to one aspect of the present invention. It is called Ego because it places itself at the centre of its data processing and first of all views and evaluates everything from its own perspective. Therefore, the Ego does not need to be given or trained any data with its meaning (for example, identification of images); it creates everything itself.

### Subjective Polar Coordinate System:

All data of the observations and experiences of this AI are subjective or are made from the perspective of the Ego according to one aspect of the present invention. The spatial concept also follows this idea. No Cartesian coordinate system with an assumed origin somewhere in the observed environment is designed, in which the respective coordinates are assigned to each recognised object. Instead, a polar coordinate system can be used. This not only automatically determines the mathematical origin in the Ego, but also the subjective orientation of the Ego with front-back, top-bottom, right-left including the motion vector. The surrounding (empty) space is taken for granted. The observed objects are only recognised via the distance to one's own point of view, i.e. the origin of the polar coordinate system, and the angle. Empty space in the physical sense is therefore not assumed to be a separate entity or dimension. It is there and is simply an option to move there, unless there is, stands or moves another object (there), then the ‘place’ would be occupied or the space would not be empty. A further advantage of the subjectivist polar coordinates arises in the following for the concept of Alter Egos (see below).

### Juvenile Phase:

Within unconditional requirements, such as the integrity of the observed objects and the robot itself, the maintenance of operational readiness (battery charge status), objectives such as smooth acceleration and braking and optimised cornering and others, the robot should/can learn the use of its effectors and the resulting consequences itself, above all in order to coordinate its effectors with its internal and external sensors and to fine-tune them through the increasing education 100-105, occasionally interrupted by rest phases, for example to recharge the batteries, and to maintain the internal database (redundancy, consistency, . . . ) until the recognised error from planning and results has become sufficiently small. In the case of a car, this would primarily involve accelerating, steering, braking, reaching a destination (success) or missing it (error), etc. At first, the Ego sets itself simple goals for simple actions that are carried out and memorised with results, which are later put together to form increasingly complicated ‘choreographies’. This educating phase comes to an end when the actions of the self-set or externally set goals (“go there”) cannot be further optimised, i.e. when the mathematical module cannot or can only marginally reduce the error and/or the database can hardly be optimised (number and position of points in the memory). If the error reduction decreases ever more slowly, the juvenile phase draws ever closer to its end. An ANN, on the other hand, requires a large amount of specifically selected training data, whereas the Ego only needs a real environment, one could say a playroom, where it cannot cause any damage in order to try out and exercise its own abilities. It follows intrinsic goals and not externally predetermined ones like an ANN and thus no interpretation of the environment or world.

### Adult Phase:

In the juvenile phase, the device has learnt the orderly sequence of its effector applications to achieve the set goals. What is the value of the knowledge and experience gained in the juvenile phase? All the data about the world that the Ego has learnt in the world in which it moves are its own data, its own observations and its own experiences. In a superordinate scientific-theoretical or philosophical sense, it must be stated that this data is true from the Ego's point of view, in the sense of that-is-so or that-was-so. This represents a natural and fixed starting point for cognition. Of course, the Ego must maintain its internal data. In addition to the optimisation already mentioned above, it must also ensure that it is free of contradictions and errors. Otherwise, the manufacturer or operator of the robot could not assume that the robot will achieve the desired goals with its conceived actions.

The self-experienced and self-induced changes in the environment, such as a change of location through accelerating, steering and braking, are experienced and stored by connecting the internal and external data. There is, and there is no need to go further behind one's own effectors to understand the causes in the sense of questions such as why does pressing the accelerator pedal lead to acceleration, steering to cornering, braking to negative acceleration. The Ego of a car only needs a there-are-three-options to change location in a targeted manner. At this level, it is the so-it-is that is important, not the why. A pigeon in the street certainly has no idea how a car or a cyclist works. However, if such a ‘road user’ were to pass it far enough, it would remain seated, but if the direction of movement is changed in its direction, it flies away. It doesn't know why, but it is aware of the behavioural possibilities and therefore pays close attention.

### Alter Ego:

When the (adult) Ego recognises an object in the observable environment via the external sensors, the Ego simply creates a copy of itself and adjusts the parameters of the copy according to the observed properties. The Ego is therefore the central template for all observable and non-observable objects and phenomena. Hence the names Ego and, as a consequence, Alter Ego for the copies.

By using the Ego as a central template, there are no longer any unknown objects. There are only unknown parameters, but these can be measured via the external sensors, estimated from personal experience (keyword: prejudice) and their possible range can be limited by further observations.

Just as the Ego calculates its behaviour using its methods, stored data and parameters and can forecast its own situation, the behaviour of Alter Egos can also be calculated using the same methods, data and adapted parameters. The assumptions made about the Alter Egos are limited to the same physical laws and to the fact that the short-term goals can be derived from the observed orientation and direction of movement. Whether the observed object is a box on the street, a kangaroo in Australia or an old lady with a walking frame.

In terms of the program, the Ego should exist as an object. A copy of the Ego can then simply be created for a new object that appears, and the parameters of the copy of the new object can then be adapted with the help of external sensors and the user's own experience. There could be a list with the Alter Egos of the current situation into which the new copy is inserted or created:

Class CEgo { ... };
CEgo Ego( ... );
// Start of education & learning, juvenile phase
...
// Beginning of the adult phase
CEgo AlterEgos[ ];
...
// new object recognised
AlterEgos[i] = Ego.clone( ); // Clone the Ego for the object
AlterEgos[i].adjust(...); // Parameter adjustment of the new object
...

The Ego has thus internally created an Alter Ego as a calculable image of an observed object in the environment and, as shown in FIG. 6B, it can form the inner loop of object recognition 311, updating the observable object parameters 312, prediction of the behaviour of the objects 313, adaptation of the sequence of effector operations 314 and a second, outer loop after reaching the target and entering a rest and (also) loading phase 315, until it continues with initialisation 310 for a new target.

It does not matter whether the observed object is familiar or completely new. If it is new, the range of possible characteristic values is greater, which requires increased attention (scanning frequency). This has the following advantages:
Every observed object is basically known!
Behaviour prediction of all external objects with own methods and data!
Humans no longer have to intervene to program in what is missing.
The Ego is constantly learning and improving its behaviour.
The Ego is capable of empathy and is aware of the current situation (see below).
The Ego can learn from observing Alter Egos (see below).
Alter Egos can embody unknown causalities and rules (see below).

FIG. 3 shows scenario 1 “a child” according to one aspect of the present invention.

When the Ego, for example the AI of a simple car, encounters another road user, in this example a child, it creates a copy of itself and adjusts the parameters (distance d to the Ego, orientation, speed vK, . . . ):

In this way, the Alter Ego can use the Ego's methods to predict where it will be and when. And by comparing this with its own calculation of when it will be where, the Ego can determine whether a potentially dangerous situation could arise in order to react accordingly, i.e. to slow down. In this way, the child's short-term behaviour can be predicted using its own methods and experience. NOTHING needs to be specially programmed or trained for the child that would not be present when this AI encounters a child for the first time.

FIG. 4 shows scenario 2 “Motorway” according to one aspect of the present invention.

Another example that shows more clearly how powerful this simple idea of Alter Egos is a situation on a motorway with a truck and two cars behind it and a car in the fast lane, of which the second car is our Ego. Based on its own knowledge of the law of force (F=m*a) of braking force, mass with the parameters of the observed cars and the lorry, i.e. with assumed mass, measured speed and assumed braking effect, the Ego can initially predict the braking distances of all road users in a possible accident situation using its own methods alone in order to determine its own safety distance. However, let us first deal with the ‘thoughts’ or the Ego's assumptions about the other road users in order to predict their actions:
The LKW0 drives at a certain speed, which the Ego (PKWEgo) has learnt (without having to be specially trained to do so) that such large road users rarely exceed it. The lorry's Alter Ego will therefore not predict any change in speed.
The PKWEgo, the centre of the observation, would be able to drive faster and would overtake the LKW0, taking into account the other road users. Overtaking would bring the PKWEgo to its destination more quickly and would therefore have a higher motivation value at the moment as it prepares to overtake.
PKW1, another Alter Ego, thinks the same as PWKEgo due to the system, because the Ego would act in its place. The Ego therefore assumes that PKW1 also wants to overtake LKW0. Of course, the Alter Ego of car1 ‘sees’ the PKWEgo and will carry out its (Ego's) assumed overtaking manoeuvre, taking into account the existence of the PKWEgo, for example by setting its indicators and paying particular attention to the PKWEgo and other possible road users in the overtaking lane. This would be what the Ego of the PKWEgo ‘thinks’ and how it would predict the behaviour of PKW1.
Another possible road user, PKW2, is approaching in the fast lane at high speed. The Ego also creates an Alter Ego for this and devises its action prediction based on the clear lane.
As shown above, the program, the Ego, can forecast the entire situation with all relevant road users and plan its own sequence of effector operations accordingly so that no dangerous developments occur.

### Alter Ego, Consciousness:

The Ego therefore has a complete internal understanding of the observable environment with all recognised objects and the ability to predict their behaviour in the short term. This would be a possible and programmatically implementable definition of consciousness, a real one, not a faked or imitated one.

The short-term behavioural prediction based on the ability to put oneself in the place of the observed objects means looking at the situation with all the data converted for the Alter Egos and calculating the development of the situation using the calculated probable behaviour of the observed objects.

The Ego in the motorway situation above can be used for all observed objects without having to program extra routines:
predict their behaviour on the assumption that all road users want to move as quickly as possible and without accidents,
continuously adjust the predictions with the observed actual behaviour (braking, accelerating, steering, setting indicators, activating the headlight flasher, etc.) and
overtake the lorry at a suitable moment.

The possible behaviour of all those involved in this situation can be easily assessed by the Ego by applying its own methods and experiences (data) to them with the appropriate parameters. Don't humans do the same?

The examples make it clear that the basis, the foundation and the starting point of this AI is always the Ego, the central template. The more differentiated its internal and external sensory capabilities and the better its education in the juvenile phase, the more intelligent its behaviour and the greater its potential to predict the behaviour of observed objects. If the Ego were also given a parameter for its own vulnerability—in the case of a car, one would probably speak of deformability—the Ego could also assess the risks of strong or weak contact. BUT, ONLY the Ego has to be built, programmed and educated (once), whereby the last part can of course also be transferred by an educated Ego. Observed objects do not have to be identified (ANNs and their training data), nor does the behaviour of the identified objects have to be programmed. Of course, one could argue that the Ego is not sufficient to predict the behaviour of other road users. But you only have to think about how humans try to predict the behaviour of other road users. Humans also do not know the long-term goals of road users on a motorway; they can only guess at the short-term goals of other road users (to move forward as quickly as possible without an accident) and prepare themselves accordingly.

### The Robot's Capabilities:

### Empathy:

It was shown above how the Ego can use Alter Egos to put itself in the shoes of the observed objects in its environment in order to calculate their behaviour from their point of view. You can call it empathy if you don't reserve the term exclusively for humans.

Learning from Observation:

Learning from observation means observing behaviour that may be better than one's own and, if possible, adopting it. The basis is the comparison between other people's behaviour and your own and this comparison is made possible by the empathy defined above.

Empathy of the Ego is realised here via Alter Egos, through which the Ego places itself in the situation of other observed objects in order to predict their behaviour from their view of the environment. Let us assume that there is now a difference between predicted and observed behaviour. And if the Alter Ego now changes the sequence of actions of the effectors in such a way that the observed behaviour is reproduced, the Ego has the opportunity to copy the observed behaviour if it offers an advantage.

FIG. 5 shows scenario 3 different “curve behaviour”.

Let's imagine that the Ego has learnt to always take a bend at the same distance from the right-hand edge of the road, the LE line. Now it observes a car in front that cuts off the bend by turning earlier but less sharply, which also reduces lateral acceleration and therefore drives round the bend faster, on the dotted bend LB.

Seen in this light, the empathy described here is a prerequisite for learning from observing and imitating the behaviour of others. (There is no reason not to assume that the same applies to humans, i.e. learning through imitation on the basis of empathy).

If the data from the external sensors, converted to the situation and position of the Alter Ego, is now linked to the stored, simple and more complex sequences of actions of the Ego, which have been copied into the Alter Ego, the Ego is able to learn from the observation: It can recognise the difference between the self-planned sequence of actions of its own effectors (always the same distance to the edge of the road) and the observed sequence (earlier braking and turning, smaller steering movement and higher cornering speed and earlier acceleration) and realise that it could drive faster through the bends in this way. This form of learning is certainly faster than the usual trial-and-error approach.

### Recognising Causal Laws:

The section on theory formation explained how any observed functional relationship can be replicated. Let's use this ability to recognise natural laws, for which Alter Egos are also used if necessary and appropriate. Of course, they are not lying or driving on a road, but they cause changes that can be detected by external and/or internal sensors.

Let's imagine an experiment in which our AI Ego observes a falling apple. It creates an Alter Ego and notices the accelerated movement towards the earth. Now the Ego's first assumption will be that the apple itself has caused the acceleration; like the car Ego, it has its own ‘accelerator pedal’ to accelerate itself. But then the Ego will observe that no apple moves on the ground itself and that other things also fall to the ground and then stop moving there. In addition, the Ego itself should have learnt the law of gravity. On a sloping road, without pressing the accelerator pedal, it would have noticed and learnt an acceleration, but only ever ‘downhill’, whereas ‘uphill’ it has to accelerate more. The steeper the angle α, the greater the force according to the formula we know (with g=acceleration due to gravity, 9.81 m/sec2):

$$F = m * g * sin ( α ) \qquad ( 2 )$$

Remember, the Ego of course does not explicitly know this equation or the equation for free fall, i.e. the law of gravity) (sin(α=90°)=1), but via the data points and the piecewise linear interpolation or extrapolation it has an implicit knowledge of this relationship between the relevant variables.

The Ego therefore behaves as if it knew that, as a physicist would say, as a body with a heavy mass it is subject to the above law of mass attraction. If it now sees another object and creates its Alter Ego, the Alter Ego is also subject to this mass attraction. In this way, this realisation takes on the status of a law of nature that affects all bodies without having to be programmed into them. If the behaviour of such an Ego were to be viewed from the outside, it would be impossible to say whether it actually knows the law of gravity, as a physicist does, or whether it is only feigning this insight. Even if the Ego sees a pigeon sitting on the street, which flies away as soon as the Ego approaches, it can recognise that wing beat and upward acceleration correspond.

Another example would be a strong crosswind. Assume the Ego is a large empty van. During normal straight-ahead driving, the lateral acceleration is zero. But then the van is suddenly shifted sideways while travelling straight ahead and the lateral acceleration sensor is triggered. In this case, the Ego can simply create a new Alter Ego for the unexpected force and the unknown cause and link it to this lateral acceleration. If the Ego can then also record the data of the environment, such as in the forest or on the plain, or the movement of branches and add it to the data memory, the Ego has not only recognised a previously unknown variable (crosswind), it has also recognised a possible causal connection. If the Ego could also see and judge the extent of the movement of the branches, it could even estimate the strength of the force acting on the side and thus the probable influence on the driving behaviour. In this way, the Ego itself has created a theory with a new variable. Similar to the physicists who introduced dark matter and dark energy, although not visible or observable, or like the Nobel Prize winner Peter Higgs, who conceived a particle in the 1960s that was then detected for the first time at Cern in 2012. The Alter Ego, i.e. the copy of the self, can of course never recognise the true nature of a phenomenon with this approach in the sense of a search for truth, but it is sufficient for a competent understanding of the situation.

### Self-Assessment:

The first form of gaining knowledge has already been described. The example of the crosswind was developed in the section on “Recognising causal laws”. A force (initially) unknown to the Ego suddenly generates a lateral acceleration on a straight line, a measurable effect on the robot or the Ego. It creates an Alter Ego for this. However, there is initially no further information that signals to the Ego when the phenomenon occurs and how strong it is. Only when the Ego observes a temporal correlation between the movements of the branches, sometimes stronger and sometimes weaker, and its own lateral acceleration, sometimes none and sometimes yes, can the Ego link the two and assume the same cause for both. What happens here? The Ego cannot recognise the crosswind itself, but it can recognise its own reaction to it (lateral acceleration) and the reaction of the branches. This creates an element that sometimes has an effect on the Ego and sometimes not, but which not only has an effect on the Ego, but also on other observable objects.

The second form of gaining knowledge is based on the comparison of one's own behaviour with that of other objects. The prerequisite is the assumption that the behaviour of the observed objects is ‘rational’ and not randomised, although this could also be recognised as such, whereby the comparison would then no longer be a requirement for a possible gain in knowledge. Two different behavioural comparisons are carried out, whereby the Ego can determine whether its own competence (see below) is inferior, equal or superior to that of the observed objects in a situation. This means that the observed objects can perceive more, the same, or less of the situation. An observed van suddenly slows down on a straight road. It seems to see something that is unknown to the observing Ego, it recognises less than the object. If inferior competence has been identified, this can be seen as an opportunity to specifically analyse these situations in order to at least raise one's own competence to the level of others. The comparison is not about whether the behaviour is right or wrong, which would only lead to the well-known problems of truth theories, but only about whether and when a behaviour changes and whether behaviours are repeated. The first comparison of behaviour concerns different situations: Do the observed objects in situations that are different for the Ego also show different behaviours? The second comparison concerns the same situations: Does the behaviour of the observed objects repeat itself in situations that are the same for the Ego or does it vary? The Ego can draw conclusions from these observations of several situations over a longer period of time,
that one's own competence is inferior if objects repeatedly observed in situations that are the same for the Ego show different behaviour and also vary their behaviour in situations that are different for the Ego,
that one's own competence is superior if objects observed repeatedly repeat their behaviour in situations that are the same for the Ego, but also do not vary their behaviour in situations that are different for the Ego,
that one's own competence is equivalent if objects observed repeatedly repeat their behaviour in situations that are the same for the Ego but vary their behaviour in situations that are different for the Ego.

With this simple comparison, the Ego can recognise how great its own competence is in certain situations in comparison to other objects. Mind you, this is not an attempt to compare with the “truth of the real world”.

From these comparisons, the Ego can evaluate itself and deduce, for example, whether it should behave more cautiously in certain situations and try to identify what is not (yet) recognisable. It can be understood as an internal mission to conduct targeted research as part of “continuous learning and the ongoing expansion of cognition and knowledge” (see above).

### Competence:

However, the result of these comparisons can also be used to externally assess the competence of the robot's abilities in order to decide on its possible applications. In contrast to the truth of knowledge about the real world that the Ego has acquired, there are no linguistic problems in comparing competences and in determining greater or lesser competence.

However, the concept of truth in relation to theories has another important aspect that competence must also fulfil. Theories make predictions possible. It is therefore important to know the quality of a theory and, subsequently, its predictions. In general, the attribution of truth to a theory serves as a criterion for being able to apply it, for being allowed to apply it, with the advantage that the criterion of truth automatically excludes all competing theories and thus eliminates the problem of deciding which theory to use. The concept of competence must achieve something comparable.

Competence is defined and used here as the ability to understand the relevant influencing factors of a situation or similar situations. It is therefore initially a limited criterion, but its level can be determined in a comparative procedure, in contrast to the truth of a theory, which assumes unlimited validity in terms of time and space. However, this can neither be proven nor does the criterion allow different theories to be compared with each other.

This means that competence is better suited to describing the capabilities of a robot than the concept of truth and, unlike truth, it can be determined by the robot itself in a formal process for self-assessment.

FIG. 6A shows a schematic flow chart of a procedure for autonomous control of a device in the juvenile or educating phase. The aim and end of the phase is to use and deploy the effectors with sufficient precision and to minimise errors. Initialisation 200 is followed by the randomised actuation 201 of effectors and the readout 202 of a plurality of internal sensor units set up to measure internal device properties and a readout 203 of a plurality of external sensor units set up to measure external environmental properties; a storing 204 of correlations which exist between the actuation 201 of the effectors and the readout device properties and environmental properties as action instructions, such that an action instruction is an initial triple of actuation 201, device properties and environmental properties into a target triplet an actuation 205 of the device in accordance with at least one predefined target device property and/or at least one predefined target environment property using at least one stored 204 action instruction which specifies how the at least one predefined target device property and/or the at least one predefined target environment property is set on the basis of the initial triplet and the target triplet.

FIG. 6A shows the juvenile phase:
200 Initialisation as preparation for learning
201 Randomised actuation of the effectors
202 Readout 202 of a large number of internal sensor units
203 internal device characteristics and a readout 203 from a plurality of external sensor units
204 Saving 204 interrelationships
205 Determine the error in movement precision, immediately, if too large continue at 201

### Optional: Rest Phase for Recharging and Ex Post for Data Preparation:

Errors, redundancy, consistency, . . . .

FIG. 6B shows the adult phase:
310 Initialisation as preparation for achieving a longer-term goal
311 Recognising the objects 311 in the current situation
312 Creating or updating Alter Egos or their parameters 312
313 Behavioural prediction 313 of the observed objects using the current Alter Egos
314 Calculation of the optimum effector deployment 314 for the further pursuit of your own goals
315 Rest phase 315 for recharging and ex post data preparation:
   Errors, redundancy, consistency.

In this document, robots, devices, systems and Ego are used synonymously.

1. A method for autonomously controlling a device, the method comprising the following steps:
Initialising (100) by means of randomised actuation (101) of effectors and reading (102) a plurality of internal sensor units set up to measure internal device properties as internal states and a reading (103) of external environmental properties as external states by a plurality of external sensor units set up for measurement,
whereby an object is detected by means of the external sensor units and its detected parameters are compared with device properties and instructions for action of the devices and the detected parameters are used to predict the behaviour of the detected object,
whereby an action instruction as a mapping function transfers an initial triplet of actuation of the effectors, device properties and environmental properties into a target triplet that specifies a new internal state, a new external state and possible actions that are possible in the new states,
storage (104) of interrelationships existing between the actuation (101) of the effectors and the readout device properties and environmental properties as instructions for action; and
controlling (105) the device according to at least one predefined target device property and/or at least one predefined target environment property using at least one memorised (104) action instruction, which indicates how the at least one predefined target device property and/or the at least one predefined target environment property is set using the initial triplet and the target triplet, the method being iterated in a learning manner, in which new action instructions are constantly recognised, which in each case convert an initial triplet into a target triplet and these action instructions are stored for controlling the device.

2. The method according to claim 1, characterised in that the method is iterated in a learning manner in such a way that new action instructions are always recognised, which in each case convert an initial triplet into a target triplet and these action instructions are stored for actuating (105) the device.

3. The method according to claim 1 or 2, characterised in that the readout (102, 103) of internal and/or external effectors is carried out in such a way that individual support values are stored and intermediate values are interpolated and/or extrapolated.

4. The method according to one of the preceding claims, characterised in that the target device property and/or the target environment property is at least temporarily influenced by a device property and/or an environment property.

5. The method according to one of the preceding claims, characterised in that a plurality of action instructions are combined to form a choreography which converts an initial triplet into a target triplet.

6. The method according to one of the preceding claims, characterised in that an object is detected by means of external sensor units and its detected parameters are compared with device properties and/or instructions for action of the devices.

7. The method according to claim 6, characterised in that the detected parameters are used to predict the behaviour of the detected object.

8. The method according to one of claim 6 or 7, characterised in that interrelationships of the detected object between its parameters and its actions are used to generate instructions for action of the device.

9. The method according to one of the preceding claims, characterised in that an effector is present as a processor, a memory, a motor, a gripper arm, a motion unit, a drive, an extremity, a windscreen wiper, a flasher, a light, a steering and/or an executive unit.

10. The method according to one of the preceding claims, characterised in that internal sensor units detect an effector state, an effector setting, an effector position, a size, a weight, a dimension, a speed, an acceleration, a deceleration, a battery level, a range, a position, a processor utilisation, a memory utilisation and/or a system parameter of the device.

11. The method according to one of the preceding claims, characterised in that external sensor units detect a distance, an object, a lidar signal, an image signal, a position, a size, a dimension, an acoustic signal and/or an external parameter.

12. An apparatus adapted to carry out a method according to any one of the preceding claims, comprising:
an initialisation unit set up for initialising (100) by means of randomised actuation (101) of effectors and reading out (102) a plurality of internal sensor units set up for measuring internal device properties as internal states and reading out (103) external environmental properties as external states by a plurality of external sensor units set up for measurement,
whereby an object is detected by means of the external sensor units and its detected parameters are compared with device properties and instructions for action of the devices and the detected parameters are used to predict the behaviour of the detected object,
whereby an action instruction as a mapping function transfers an initial triplet of actuation of the effectors, device properties and environmental properties into a target triplet that specifies a new internal state, a new external state and possible actions that are possible in the new states,
a memory unit arranged for storing (104) interrelationships which exist between the actuation (101) of the effectors and the readout device properties and environmental properties as instructions for action; and
a control unit arranged to control (105) the device according to at least one predefined target device property and/or at least one predefined target environment property using at least one memorised (104) action instruction, which indicates how the at least one predefined target device property and/or the at least one predefined target environment property is set using the initial triplet and the target triplet, wherein the method to be executed by the device is iterated in a learning manner, in which new action instructions are always recognised, which in each case convert an initial triplet into a target triplet and these action instructions are stored for controlling the device.

13. A system arrangement comprising several devices according to claim 12 which are coupled by means of communication technology and exchange instructions for action.

14. A computer program product comprising instructions which, when the program is executed by at least one computer, cause the computer to perform the steps of the method according to any one of claims 1 to 11.

15. A computer-readable storage medium comprising instructions which, when executed by at least one computer, cause the computer to perform the steps of the method according to any one of claims 1 to 11.
